(19) United States
(12) Patent Application Publication
(10) Pub. No.: US 2011/0216114 A1
(43) Pub. Date: Sep. 8, 2011

(54) PRINTING APPARATUS AND METHOD OF CONTROLLING PRINTING APPARATUS

(75) Inventor: Takashi Koase, Shiojiri-shi (JP)

(73) Assignee: Seiko Epson Corporation, Tokyo (JP)

(21) Appl. No.: 13/042,505

(22) Filed: Mar. 8, 2011

(30) Foreign Application Priority Data
Mar. 8, 2010 (JP) 2010-050444

(51) Int. Cl. B41J 29/38

(52) U.S. Cl. 347/9

(57) ABSTRACT

There is provided a printing apparatus includes a head having a slow-permeation-black-nozzle-group which discharges slow-permeation-black-ink, and an excessive-permeation-black-nozzle-group which are arranged at the same pitch as the slow-permeation-black-nozzle-group and are deviated from the slow-permeation-black-nozzle-group by ½ pitch in a sub scanning direction, and a control unit which controls scanning of the head in a main scanning direction and ink discharging through each group. In the printing apparatus, the control unit controls to perform printing in any one of a plurality of printing modes including a normal printing mode in which printing is performed such that slow-permeation-black-ink is discharged through the slow-permeation-black-nozzle-group while excessive-permeation-black-ink is not discharged through the excessive-permeation-black-nozzle-group, and a high-speed printing mode in which printing is performed such that slow-permeation-black-ink is discharged through the slow-permeation-black-nozzle-group and excessive-permeation-black-ink is discharged through the excessive-permeation-black-nozzle-group.

### BACKGROUND

1. Technical Field

The present invention relates to a printing apparatus using excessive permeation ink and slow permeation ink and a method for controlling the printing apparatus.

2. Related Art

There is an existing ink jet printing apparatus which uses excessive permeation ink having high permeability into a recording medium for color ink and uses slow permeation ink having low permeability into a recording medium for black ink.

For example, a following ink jet printer is disclosed in JP-A-4-147866. The ink jet printer which prevents color mixing bleed of color ink by making permeation time and fixing time of the color ink shorter. Permeation time and fixing time are made shorter by using excessive permeation color ink containing hexalene glycol of which amount is larger than a normal case. The hexalene glycol has an action of dissolving water resistant agent of a recording paper.

In JP-A-4-147866, excessive permeation ink is used for color ink so as to suppress color mixing bleed of different colors of inks landed at positions adjacent to each other. Further, in JP-A-4-147866, slow permeation ink is used for black ink so as to realize clear print quality with high density when a character printing or the like is performed, in particular.

However, although the slow permeation ink can realize clear print quality with high concentration, spreading (permeation) of the ink from a landed position is small. In particular, in a high-speed mode printing in which a movement speed of a head is faster than that in a normal mode, discharged ink is landed so as to be spread in a movement direction (main scanning direction) of the head. Therefore, in the high-speed mode printing, the ink is less spread in a sub scanning direction, instead. This causes a problem that a so-called white band is generated. The white band is a space formed between inks landed at positions adjacent to each other in the sub scanning direction.

### SUMMARY

An advantage of some aspects of the invention is to provided a printing apparatus which can keep high print quality and prevent a white band from being generated even when a print speed is set to be high and a method for controlling the printing apparatus.

A printing apparatus according to an embodiment of the invention includes a print head which includes a first nozzle group in which a plurality of nozzles which discharge slow permeation black ink are arranged at a predetermined pitch in a sub scanning direction, and a second nozzle group in which a plurality of nozzles which discharge excessive permeation black ink are arranged at the same pitch as the first nozzle group in the sub scanning direction and are deviated from the first nozzle group by ½ pitch in the sub scanning direction, and a control unit which controls scanning of the print head in a main scanning direction and ink discharging through the first and second nozzle groups. In the printing apparatus, the control unit controls to perform printing in any one of a plurality of printing modes including a first printing mode in which printing is performed such that slow permeation black ink is discharged through the first nozzle group while excessive permeation black ink is not discharged through the second nozzle group, and a second printing mode in which a movement speed of the print head is faster than that in the first printing mode, one band is printed with one scanning of the print head and printing is performed such that slow permeation black ink is discharged through the first nozzle group and excessive permeation black ink is discharged through the second nozzle group.

With the configuration, even when the print speed is set to be high, a white band can be prevented from being generated while keeping high print quality.

According to an embodiment of the invention, it is preferable that the control unit control to change a mixing ratio of excessive permeation black ink to slow permeation black ink such that as a pixel value is made larger, a ratio of the excessive permeation black ink with respect to a discharged ink amount is larger, in the second printing mode.

With the configuration, when a pixel value is small and black ink is intended to be discharged with spaces, a ratio of an ink amount of slow permeation ink having low permeability is made larger so that spaces between dots are set not to be filled. On the other hand, when a pixel value is large and black ink is intended to be discharged without spaces, an ink amount of excessive permeation ink having high permeability, which is easily spread, is made larger so that spaces between dots formed by the slow permeation ink in the sub scanning direction can be filled.

According to an embodiment of the invention, it is preferable that the print head further include a third nozzle group in which a plurality of nozzles which discharge excessive permeation color ink are arranged at the same pitch as the first nozzle group in the sub scanning direction and are arranged such that the pitch in the third nozzle group is aligned with that in the second nozzle group in the sub scanning direction, when color printing is performed in the first printing mode, the control unit control to perform printing such that slow permeation black ink is discharged through the first nozzle group and excessive permeation color ink is discharged through the third nozzle group while excessive permeation black ink is not discharged through the second nozzle group, and when color printing is performed in the second printing mode, the control unit control to perform printing such that slow permeation black ink is discharged through the first nozzle group, excessive permeation black ink is discharged through the second nozzle group, and excessive permeation color ink is discharged through the third nozzle group.

With this configuration, in color printing in the first printing mode, high quality color printing with less color mixing bleed can be performed on color portions and clear print quality with high density can be ensured on black portions by using slow permeation black ink. In addition, in the color printing in the second printing mode, color printing in which color mixing bleed is prevented from being caused while preventing a white band from being generated can be performed and clear print quality with high density can be ensured by the slow permeation black ink while preventing a white band from being generated on black portions.

### BRIEF DESCRIPTION OF THE DRAWINGS

The invention will be described with reference to the accompanying drawings, wherein like numbers reference like elements.

FIG. 1 is a block diagram illustrating a configuration of a printing system including a printing apparatus according to an embodiment of the invention.

FIG. 2 is a block diagram illustrating a nozzle group provided on a head in FIG. 1.

FIG. 3 is a table showing used inks depending on print conditions.

FIG. 4 is a flowchart illustrating a processing of a host-side controller when a print color is monochrome.

FIGS. 5A and 5B are views illustrating a state of black ink landed onto a recording paper in each printing mode.

FIG. 6 a flowchart illustrating a processing of the host-side controller when a print color is color.

FIG. 7 is a graph illustrating a relationship between a pixel value and a discharge amount of black ink.

FIGS. 8A and 8B are descriptive views illustrating a state where black ink is landed onto a recording paper on each pixel.

### DESCRIPTION OF EXEMPLARY EMBODIMENTS

Hereinafter, a preferred embodiment of the invention is described with reference to the drawings.

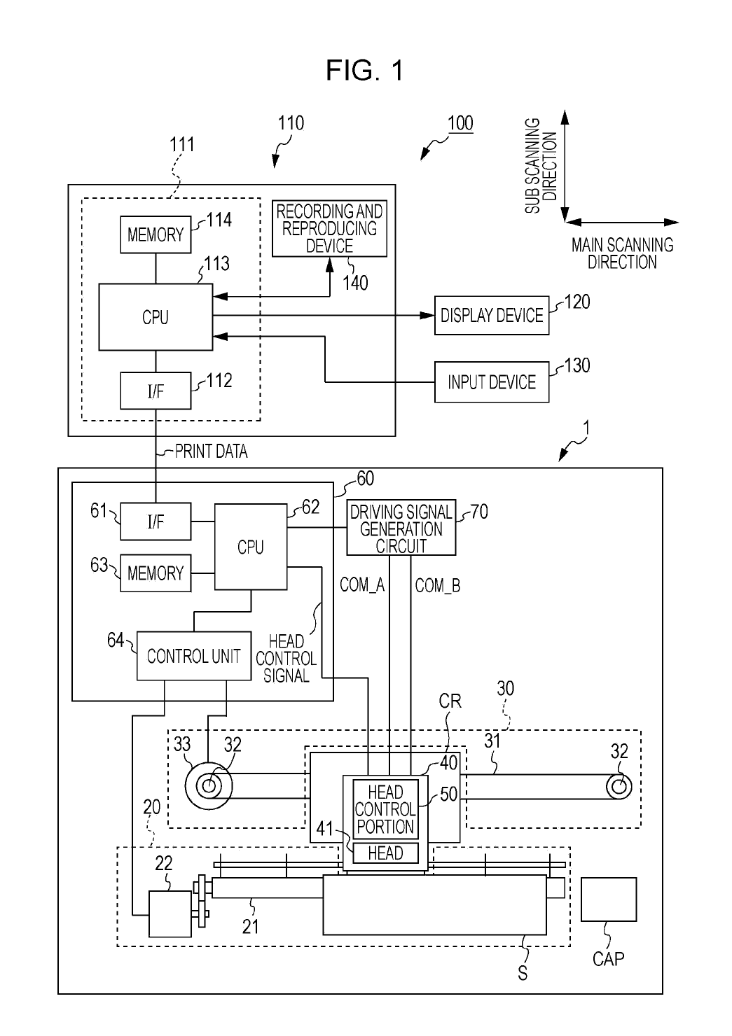

FIG. 1 is a block diagram illustrating a configuration of a printing system including a printing apparatus according to the embodiment of the invention.

A printing system 100 includes a printer 1, a computer 110, a display device 120, an input device 130 and a recording and reproducing device 140. The printer 1 forms an image by discharging ink onto a recording medium such as a paper, fabric, and a film and so on.

The computer 110 is connected to the printer 1 in a communicable manner. Computer programs such as an application program and a printer driver are installed on the computer 110. The computer 110 has a host-side controller 111. The computer 110 outputs print data corresponding to an image to the printer 1 through the host-side controller 111.

The print data is a type of data capable of being interpreted by the printer 1. The print data has various types of command data and dot formation data. The command data is data for directing the printer 1 to execute a specific operation. Further, the dot formation data is data relating to dots formed on a recording paper and is defined on a unit region basis. The unit region indicates a rectangular region which is virtually defined on a recording medium such as a recording paper and corresponds to a virtual region on which dots are formed. The unit region is formed as one pixel, for example.

The host-side controller 111 has an interface portion 112, a CPU 113 and a memory 114. The host-side controller 111 executes various types of controls with respect to operations at the side of the computer 110. The host-side controller 111 is connected to the display device 120, the input device 130, and the recording reproducing device 140 in a communicable manner. The host-side controller 111 transmits/receives print data to/from the printer 1 through the interface portion 112. The CPU 113 is an operation processing device which entirely controls the computer 110. A region in which computer programs used by the CPU 113 are stored, an operation region, and the like are ensured in the memory 114. The CPU 113 executes various types of control in accordance with the computer programs stored in the memory 114.

The display device 120 is formed of a liquid crystal display or the like, for example. A print image or a direction screen to a user is displayed on the display device 120. The input device 130 is a device with which a user inputs necessary information in accordance with the direction screen displayed on the display device 120, for example. For example, a user specifies a mode of a print speed including a high-speed mode and a normal mode, specifies a recording paper including a plain paper and a dedicated paper, selects a print color including monochrome and color, and the like in accordance with the direction screen displayed on the display device 120 from the input device 130. The various types of specification, selection, and the like input from the input device 130 are converted to command data by the CPU 113. Then, the command data is transmitted to the printer 1 through the interface portion 112 together with the dot formation data. As the recording and reproducing device 140, a flexible disc drive device or the like is used, for example.

Next, a configuration of the printer 1 is described. The printer 1 has a paper transportation mechanism 20, a carriage movement mechanism 30, a head unit 40 (head 41, head control portion 50), a printer-side controller 60, and a driving signal generation circuit 70.

The paper transportation mechanism 20 feeds a recording paper as a medium to a position where printing can be performed thereon and transports the recording paper in a sub scanning direction. The paper transportation mechanism 20 has a transportation roller 21 which transports a recording paper and a transportation motor 22 which rotates the transportation roller 21. It is to be noted that the paper transportation mechanism 20 is not limited to the above configuration as long as the paper transportation mechanism 20 can transport a recording paper.

The carriage movement mechanism 30 moves a carriage CR to which the head unit 40 is attached in a main scanning direction. The main scanning direction is a direction perpendicular to the sub scanning direction.

The carriage movement mechanism 30 has a timing belt 31, a pair of pulleys 32, and a driving motor 33, for example. The timing belt 31 is connected to the carriage CR. The pair of pulleys 32 move the timing belt 31. One of the pulleys 32 is connected to a rotational shaft of the driving motor 33.

The head unit 40 has the head 41 which discharges ink onto a recording paper and the head control portion 50 which controls an operation of the head 41. The head 41 includes a piezoelectric element (not shown). The piezoelectric element is deformed so that ink is discharged through a nozzle.

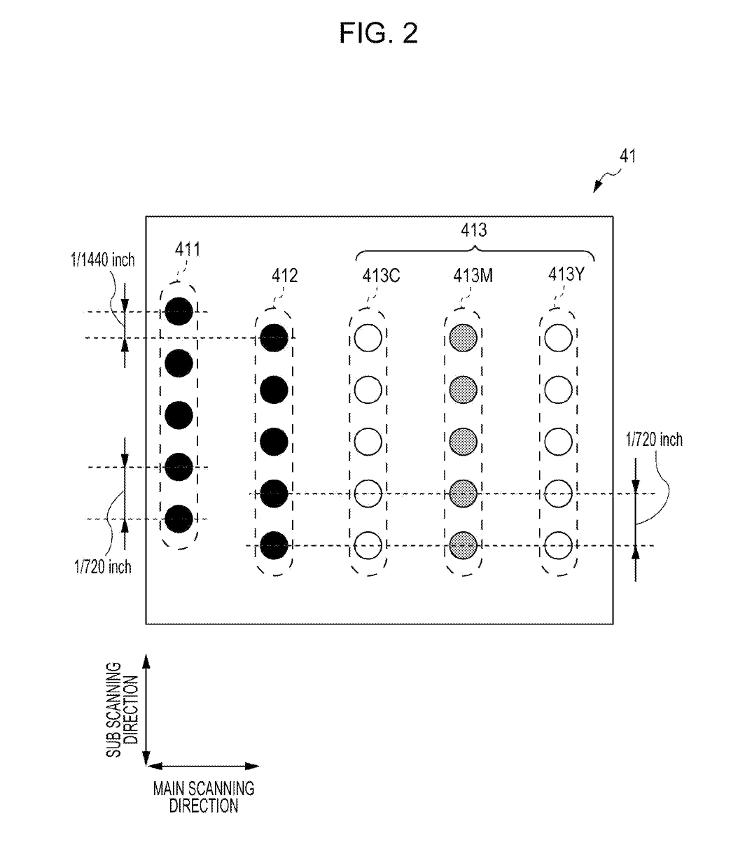

FIG. 2 is a block diagram illustrating a nozzle group provided on the head 41 of the printer 1.

The head 41 includes a slow permeation black nozzle group 411 corresponding to a first nozzle group, an excessive permeation black nozzle group 412 corresponding to a second nozzle group, and an excessive permeation color nozzle group 413 corresponding to a third nozzle group. These nozzle groups 411, 412, 413 are provided on the head 41 in parallel at substantially an equal distance in the main scanning direction.

The slow permeation black nozzle group 411 is a nozzle group through which slow permeation black ink is discharged. The excessive permeation black nozzle group 412 is a nozzle group through which excessive permeation black ink is discharged. The excessive permeation color nozzle group 413 may have a nozzle group 413C, a nozzle group 413M, and a nozzle group 413Y as shown in FIG. 2. In this case, excessive permeation C (cyan) ink is discharged through the nozzle group 413C. Excessive permeation M (magenta) ink is discharged through the nozzle group 413M. Excessive permeation Y (yellow) ink is discharged through the nozzle group 413Y. These nozzle groups 413C, 413M, 413Y are also provided in parallel at substantially an equal distance in the main scanning direction. Note that the excessive permeation ink indicates ink which does not easily cause color mixing bleed between inks at adjacent positions since a permeation speed into a recording paper is fast and ink is preferably fixed onto the recording paper. On the other hand, the slow permeation ink indicates ink of which permeation speed into a recording paper is slow and spreading is reduced in comparison with those of the excessive permeation ink. However, with the slow permeation ink, clear print quality with high density can be obtained.

A plurality of nozzles are arranged on each of the nozzle groups 411, 412, 413C, 413M, 413Y at a predetermined pitch in the sub scanning direction. In an example as shown in FIG. 2, five nozzles are arranged on each of the nozzle groups 411, 412, 413C, 413M, 413Y at 1/720 inch pitch. However, the pitch and number of nozzles in each of the nozzle groups 411, 412, 413C, 413M, 413Y are not limited thereto.

Each nozzle in the excessive permeation black nozzle group 412 and each nozzle in the excessive permeation color nozzle groups 413C, 413M, 413Y are arranged at the same pitch in the sub scanning direction and aligned in a line in the main scanning direction.

On the other hand, each nozzle in the slow permeation black nozzle group 411 is arranged in a state where each nozzle is deviated from each nozzle in the excessive permeation black nozzle group 412 and each nozzle in the excessive permeation color nozzle groups 413C, 413M, 413Y by ½ pitch in the sub scanning direction. For example, in an example as shown in FIG. 2, each nozzle in the slow permeation black nozzle group 411 is arranged so as to be deviated from each nozzle in other nozzle groups 412, 413C, 413M, 413Y by 1/1440 inch pitch in the sub scanning direction.

Description is given with reference to FIG. 1 again. The head control portion 50 applies necessary driving signals (COM_A, COM_B) to the piezoelectric element among signals generated in the driving signal generation circuit 70 based on a head control signal transmitted from the printer-side controller 60 which will be described later. The piezoelectric element is deformed in accordance with the applied driving signals.

The printer-side controller 60 controls each part at the side of the printer 1 based on the print data transmitted from the computer 110. For example, the printer-side controller 60 controls the paper transportation mechanism 20, the carriage movement mechanism 30, the head 41, the head control portion 50, and the driving signal generation circuit 70.

The printer-side controller 60 executes control in accordance with print conditions based on the command data transmitted from the computer 110. The print conditions include mode specification of a print speed including a high-speed mode and a normal mode, specification of a recording paper including a plain paper and a dedicated paper, selection of a print color including monochrome and color, and the like, which have been directed by a user through the input device 130. Detail control methods in accordance with the print conditions will be described later.

The printer-side controller 60 has an interface portion 61, a CPU 62, a memory 63, and a control unit 64. The interface portion 61 transmits/receives print data to/from the computer 110. The CPU 62 is an operation processing device which entirely controls the printer 1. A region in which computer programs used by the CPU 62 are stored, an operation region, and the like are ensured in the memory 63. The CPU 62 controls each part to be controlled in accordance with the computer programs stored in the memory 63. For example, the CPU 62 controls output of a head control signal for controlling an operation of the head 41 to the head control portion 50, output of a control signal for generating a driving signal to the driving signal generation circuit 70, and the like.

The driving signal generation circuit 70 generates a driving signal based on a control signal transmitted from the printer-side controller 60. When the driving signal is applied, the piezoelectric element is deformed so that ink is discharged through a corresponding nozzle. It is to be noted that in the embodiment, although the piezo ink jet type printer 1 has been described, the printer is not limited to the type and the printer 1 may be another type such as a thermal ink jet type.

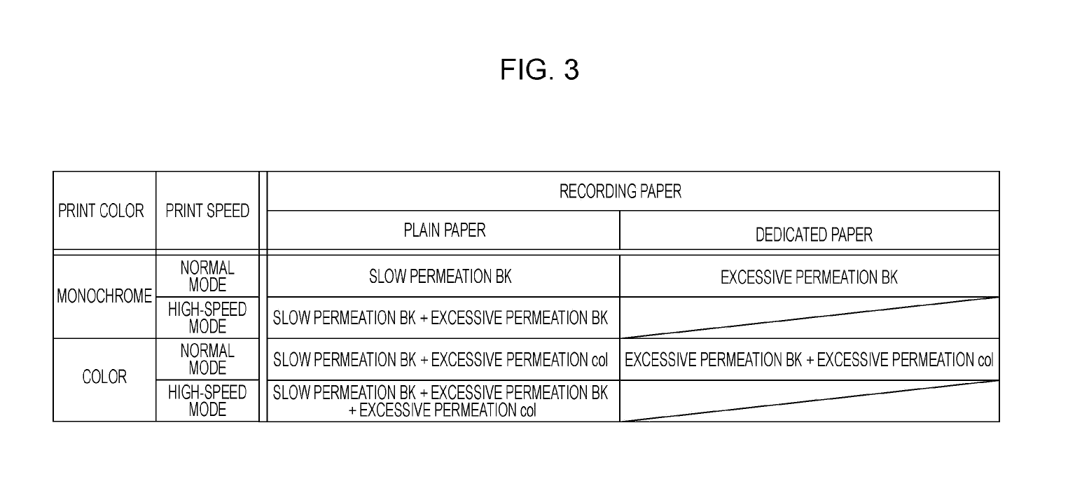

Next, a method for controlling the printer 1 in accordance with print conditions, which is executed by the printer-side controller 60 based on the command data, is described in detail. FIG. 3 is a table showing used inks depending on print conditions. A case where “plain paper” is specified in the specification of a recording paper is described, at first. In a case where a specification that a print color is “monochrome” and the “normal mode” is specified, only slow permeation black ink is used. In this case, the printer-side controller 60 controls the printer 1 to perform printing such that the slow permeation black ink is discharged through the slow permeation black nozzle group 411 while the excessive permeation black ink is not discharged through the excessive permeation black nozzle group 412. In a case where a specification that the print color is “monochrome” and the “high-speed mode” is specified, the slow permeation black ink and the excessive permeation black ink are used. In this case, the printer-side controller 60 controls the printer 1 to perform printing such that the slow permeation black ink is discharged through the slow permeation black nozzle group 411 and the excessive permeation black ink is discharged through the excessive permeation black nozzle group 412. It is to be noted that in the high-speed mode, the movement speed of the head 41 is faster than that in the normal mode and printing for one band is performed by one scanning of the print head.

Further, in a case where a specification that the print color is “color” and the “normal mode” is specified, the slow permeation black ink and the excessive permeation color ink are used. In this case, the printer-side controller 60 controls the printer 1 to perform printing such that the slow permeation black ink is discharged through the slow permeation black nozzle group 411 and the excessive permeation color ink is discharged through the excessive permeation color nozzle group 413 while the excessive permeation black ink is not discharged through the excessive permeation black nozzle group 412. In a case where a specification that the print color is “color” and the “high-speed mode” is specified, the slow permeation black ink, the excessive permeation black ink and the excessive permeation color ink are used. In this case, the printer-side controller 60 controls the printer 1 to perform printing such that the slow permeation black ink is discharged through the slow permeation black nozzle group 411, the excessive permeation black ink is discharged through the excessive permeation black nozzle group 412 and the excessive permeation color ink is discharged through the excessive permeation color nozzle group 413.

Next, a case where the “dedicated paper” is specified in the specification of a recording paper is described. In the printing of the dedicated paper, high image quality is required in many cases. Therefore, in the case where the dedicated paper is specified, the printing mode may be set to be only the normal mode. Further, since a paper having low permeability is used in many cases as the dedicated paper, only the excessive permeation ink having good permeability may be used. Therefore, in an example as shown in FIG. 3, a case in which the “dedicated paper” and the “high-speed mode” are specified is not supposed. In a case where a specification that the print color is “monochrome” and the “normal mode” is specified, only the excessive permeation black is used. In this case, the printer-side controller 60 controls the printer 1 to perform printing such that the excessive permeation black ink is discharged through the excessive permeation black nozzle group 412 while the slow permeation black ink is not discharged through the slow permeation black nozzle group 411. In a case where a specification that the print color is “color” and the “normal mode” is specified, the excessive permeation black ink and the excessive permeation color ink are used. In this case, the printer-side controller 60 controls the printer 1 to perform printing such that the excessive permeation black ink is discharged through the excessive permeation black nozzle group 412 and the excessive permeation color ink is discharged through the excessive permeation color nozzle group 413 while the slow permeation black ink is not discharged through the slow permeation black nozzle group 411.

It is to be noted that in the embodiment, the host-side controller 111 generates print data in accordance with the print conditions as described above and the printer-side controller 60 controls the printer 1 in accordance with the generated print data. However, the method of controlling the printer 1 in accordance with the print conditions is not limited to the above method. For example, a function of the host-side controller 111 may be mounted on the printer 1.

Subsequently, a processing of the host-side controller 111 according to the embodiment is described.

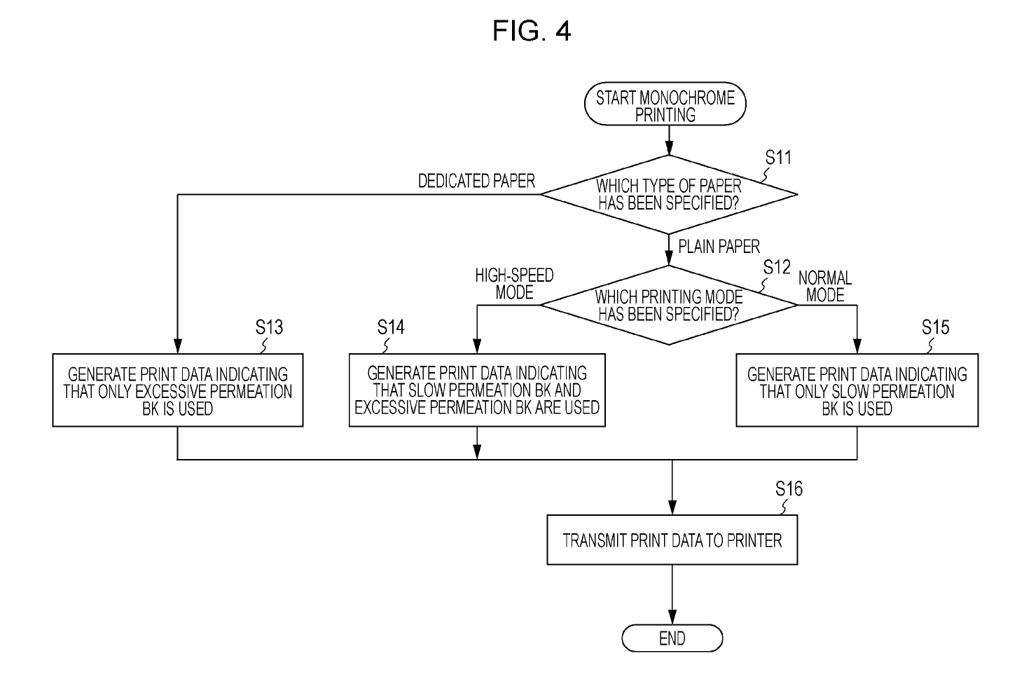

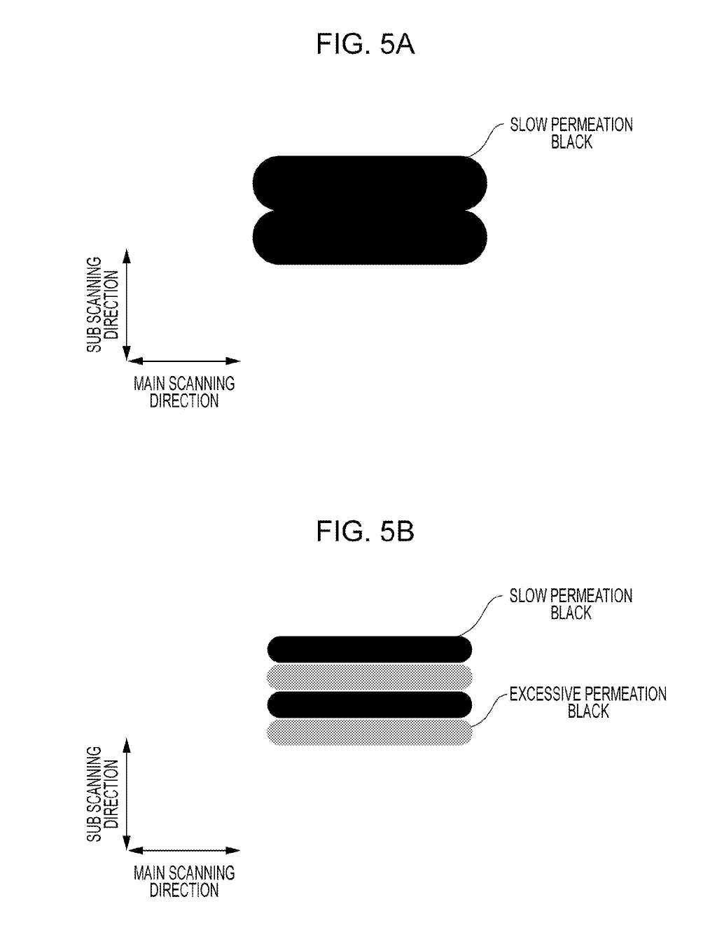

FIG. 4 is a flowchart illustrating an operation of the printer 1 when the print color is monochrome. A user specifies the print color to be “monochrome” through the input device 130. FIG. 5A is a view illustrating a state of black ink landed onto a recording paper in the normal mode. FIG. 5B is a view illustrating a state of black ink landed onto a recording paper in the high-speed mode.

The host-side controller 111 judges whether a specified recording paper is a plain paper or a dedicated paper (step S11).

When the specified recording paper is judged to be a “dedicated paper” (step S11: dedicated paper), the host-side controller 111 generates print data indicating that only the excessive permeation black ink is to be used (step S13).

The host-side controller 111 transmits the print data generated in step S13 to the printer 1 (step S16).

The printer 1 performs printing based on the print data received in step S16 by discharging ink through the excessive permeation black nozzle group 412.

With the processings, when the monochrome printing using the dedicated paper, such as monochrome photograph printing, is performed, monochrome printing using only the excessive permeation black ink suitable to a paper type can be performed.

When the specified recording paper is judged to be a “plain paper” (step S11: plain paper), the host-side controller 111 judges a printing mode (step S12).

When the printing mode is judged to be the “normal mode” (step S12: normal mode), print data indicating that only the slow permeation black ink is used is generated (step S15).

The host-side controller 111 transmits the print data generated in step S15 to the printer 1 (step S16).

The printer 1 performs printing based on the print data received in step S16 by discharging ink through the slow permeation black nozzle group 411.

As shown in FIG. 5A, in the normal mode, even if printing is performed by using only the slow permeation black ink, a space (white band) in the sub scanning direction is not generated. The reason is that the movement speed of the carriage in the normal mode is slower than that in the high-speed mode and a sufficient ink amount for spreading the slow permeation ink in the sub scanning direction can be ejected. Therefore, clear print quality with high density can be ensured by using only the slow permeation black ink.

When the printing mode is judged to be “high-speed mode” (step S12: high-speed mode), the host-side controller 111 generates print data indicating that the slow permeation black ink and the excessive permeation black ink are used (step S14).

The host-side controller 111 transmits the print data generated in step S14 to the printer 1 (step S16).

The printer 1 performs printing based on the print data received in step S16 by discharging ink through each of the slow permeation black nozzle group 411 and the excessive permeation black nozzle group 412.

Each nozzle of the excessive permeation black nozzle group 412 is formed so as to be deviated from each nozzle in the slow permeation black nozzle group 411 by ½ pitch in the sub scanning direction. Therefore, as shown in FIG. 5B, the excessive permeation black inks are landed between the landing positions of the slow permeation black inks adjacent to each other in the sub scanning direction. That is, the excessive permeation black inks are ejected at positions between the slow permeation black inks, where white bands are to be generated. As a result, in the high-speed mode, clear print quality with high density can be also ensured by the slow permeation black ink while preventing the white band from being generated.

Next, a processing of the host-side controller 111 when the color printing is performed is described.

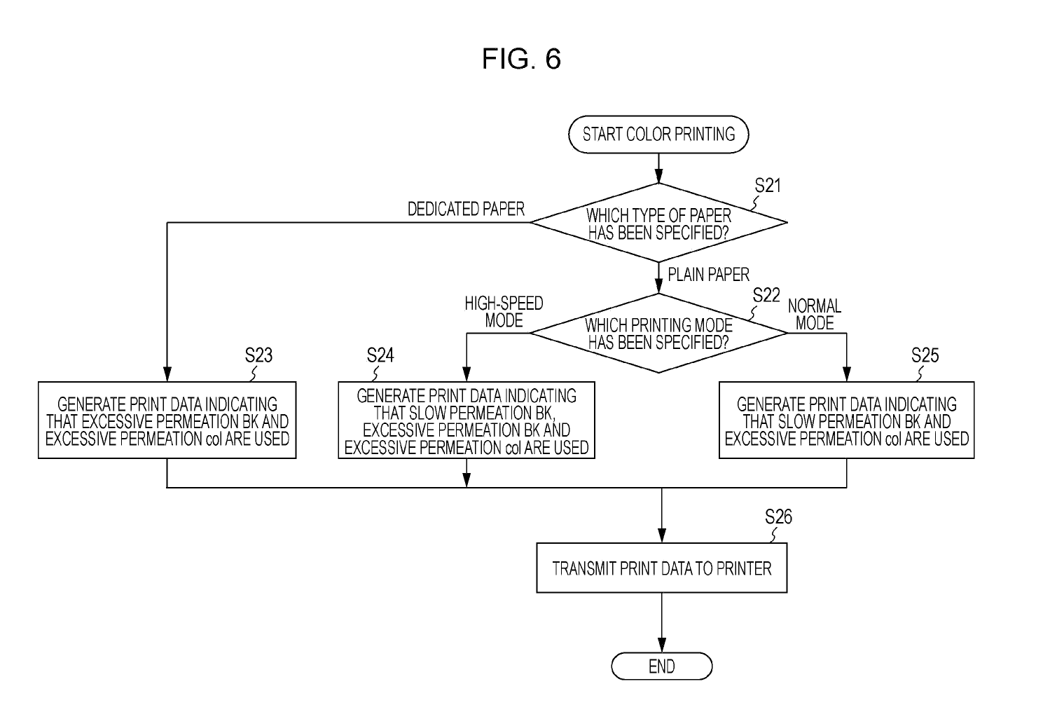

FIG. 6 is a flowchart illustrating an operation of the printer 1 when the print color is color. A user selects the print color to be “color” through the input device 130.

The host-side controller 111 judges whether a specified recording paper is a plain paper or a dedicated paper (step S21).

When the specified recording paper is a “dedicated paper” (step S21: dedicated paper), the host-side controller 111 generates print data indicating that the excessive permeation black ink and the excessive permeation color ink are used (step S23).

The host-side controller 111 transmits the print data generated in step S23 to the printer 1 (step S26).

The printer 1 performs printing based on the print data received in step S16 by discharging ink through each of the excessive permeation black nozzle group 412 and the excessive permeation color nozzle group 413.

With the processings, when the color printing using the dedicated paper, such as color photograph printing, is performed, printing using the excessive permeation black ink and the excessive permeation color ink suitable to a paper type can be performed. Further, when printing in high image quality using the dedicated paper is performed, high print quality without slur can be ensured by using the excessive permeation black ink. The excessive permeation black ink used is discharged through each nozzle in the excessive permeation black nozzle group 412 which is not deviated from each nozzle in the excessive permeation color nozzle group 413 in terms of nozzle pitch.

When the specified recording paper is judged to be a “plain paper” (step S21: plain paper), the host-side controller 111 judges a printing mode (step S22).

When the printing mode is judged to be the “normal mode” (step S22: normal mode), print data indicating that the slow permeation black ink and the excessive permeation color ink are used is generated (step S25).

The host-side controller 111 transmits the print data generated in step S25 to the printer 1 (step S26).

The printer 1 performs printing based on the print data received in step S26 by discharging ink through each of the slow permeation black nozzle group 411 and the excessive permeation color nozzle group 413.

As shown in FIG. 5A, in the normal mode, even if printing is performed by using only the slow permeation black ink, a space (white band) in the sub scanning direction is not generated on the black ink. The reason is that the movement speed of the carriage in the normal mode is slower than that in the high-speed mode and a sufficient ink amount for spreading the slow permeation ink in the sub scanning direction can be ejected, as descried above. Therefore, high quality color printing with less color mixing bleed can be performed on color portions and clear print quality with high density can be ensured by using the slow permeation black ink for black portions.

When the printing mode is judged to be the “high-speed mode” (step S22: high-speed mode), the host-side controller 111 generates print data indicating that the slow permeation black ink and the excessive permeation black ink are used (step S24).

The host-side controller 111 transmits the print data generated in step S24 to the printer 1 (step S26).

The printer 1 performs printing based on the print data received in step S26 by discharging ink through each of the slow permeation black nozzle group 411, the excessive permeation black nozzle group 412 and the excessive permeation color nozzle group 413.

With the processings, even in the high-speed mode, color printing in which color mixing bleed is prevented from being caused while preventing the white band from being generated can be performed by using the excessive permeation color ink on color portions. In addition, each nozzle in the excessive permeation black nozzle group 412 is formed so as to be deviated from each nozzle in the slow permeation black nozzle group 411 by ½ pitch in the sub scanning direction, as described above. Therefore, as shown in FIG. 5B, the excessive permeation black inks are landed between landing positions of the slow permeation black inks adjacent to each other in the sub scanning direction on black portions. Accordingly, in the high-speed mode, a clear print quality with high density can be also ensured by the slow permeation black ink while preventing the white band from being generated.

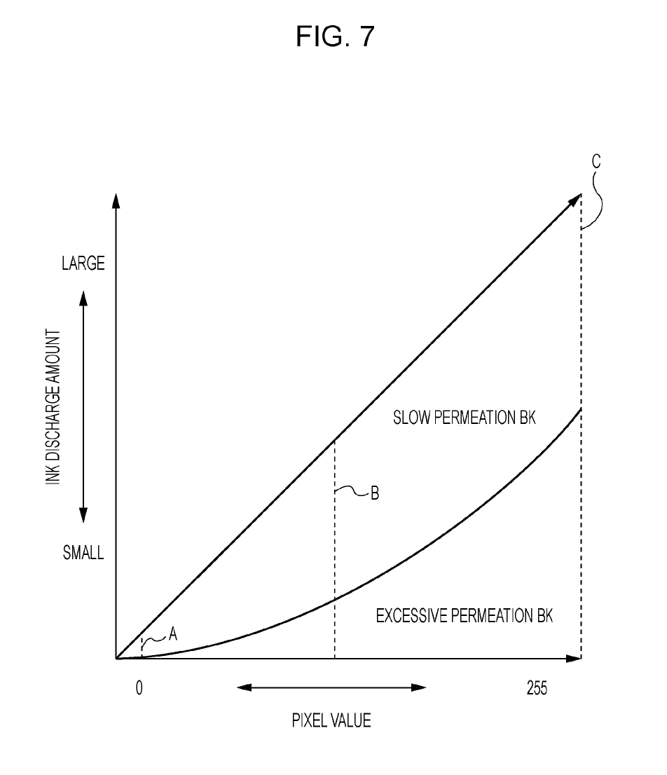

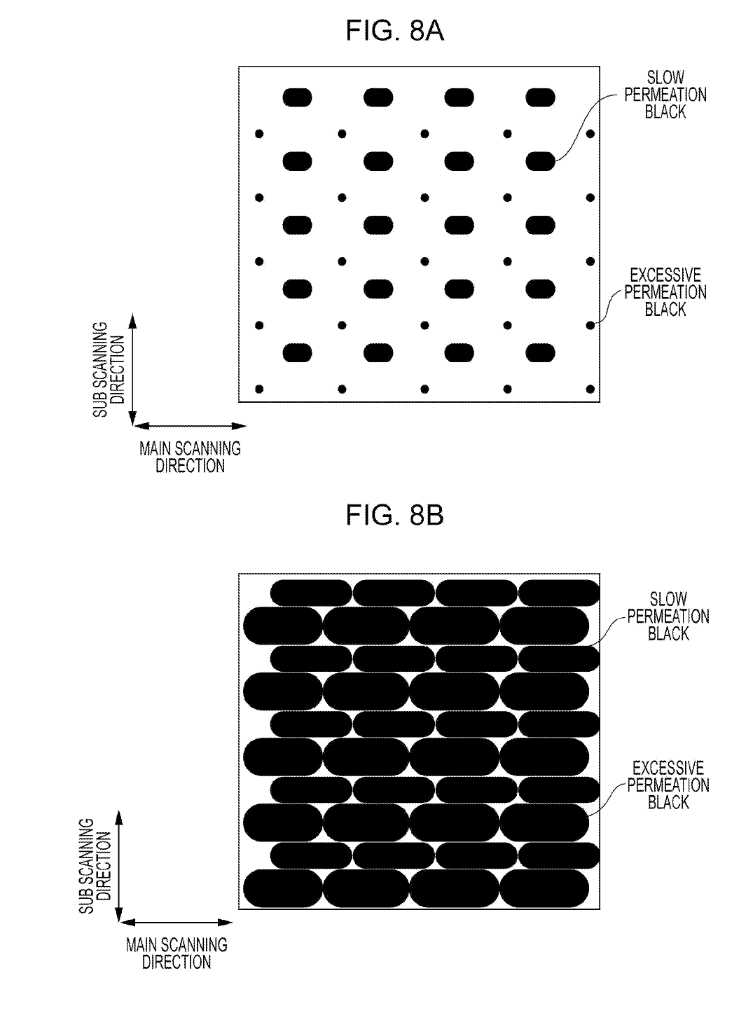

Next, a method for controlling a discharge amount of the black ink in the high-speed mode in accordance with a pixel value is described. FIG. 7 is a graph illustrating a relationship between a pixel value and a discharge amount of black ink. FIG. 8A is a descriptive view illustrating a state where black ink is landed onto a recording paper on each pixel when the pixel value is small. FIG. 8B is a descriptive view illustrating a state where black ink is landed onto a recording paper on each pixel when the pixel value is large. It is to be noted that FIGS. 8A and 8B are views for simply explaining a state where the black ink is landed and the number of dots on each pixel is not limited to that shown in FIGS. 8A and 8B.

As shown in FIG. 7, the host-side controller 111 controls to change a mixing ratio of the excessive permeation black ink to the slow permeation black ink in the following manner. That is, the host-side controller 111 controls to change the mixing ratio based on the print data such that a ratio of the excessive permeation black ink with respect to a discharged amount of black ink is made larger as the pixel value becomes larger. For example, the host-side controller 111 controls a ratio of an amount of black ink discharged through the slow permeation black nozzle group 411 to an amount of black ink discharged through the excessive permeation black nozzle group 412. In terms of the ratio of the ink amounts, when the pixel value is small, a discharge amount of the slow permeation black ink is significantly larger than a discharge amount of the excessive permeation black ink. However, the ratio of the ink amounts is changed such that as the pixel value is larger, a discharge amount of the slow permeation black ink and a discharge amount of the excessive permeation black ink become substantially equal to each other. For example, in an example of FIG. 7, an ink discharge amount of the slow permeation black ink becomes larger in proportion to the pixel value. On the other hand, an ink discharge amount of the excessive permeation black ink is increased with respect to the pixel value in an exponential manner. For example, in the example of FIG. 7, when the pixel value is A, a discharge amount of the slow permeation black is larger than that of the excessive permeation black ink at a ratio of substantially 1:9. When the pixel value is B, a discharge amount of the slow permeation black is larger than that of the excessive permeation black ink at a ratio of substantially 3:7. Further, when the pixel value is C, a discharge amount of the slow permeation black ink and that of the excessive permeation black ink are set to be approximately equal to each other at a ratio of substantially 5:5.

Therefore, as shown in FIG. 8A, when the pixel value is small and the black ink is intended to be discharged with spaces, a ratio of an ink amount of the slow permeation ink having low permeability with respect to that of the excessive permeation ink is made larger so that spaces between dots are set not to be filled. On the other hand, as shown in FIG. 8B, when the pixel value is large and the black ink is intended to be discharged without spaces, an ink amount of the excessive permeation ink having high permeability, which is easily spread, is made larger so that spaces between dots formed by the slow permeation ink in the sub scanning direction can be filled.

The above embodiment of the invention is illustrated for explaining the invention and is not intended to limit the range of the invention to the embodiment only. Those skilled in the art can execute the invention in other various modes without departing from the scope of the invention.

The entire disclosure of Japanese Patent Application No. 2010-050444, filed Mar. 8, 2010 is expressly incorporated by reference herein.

What is claimed is:

1. A printing apparatus comprising:
a print head which includes a first nozzle group in which a plurality of nozzles which discharge slow permeation black ink are arranged at a predetermined pitch in a sub scanning direction, and a second nozzle group in which a plurality of nozzles which discharge excessive permeation black ink are arranged at the same pitch as the first nozzle group in the sub scanning direction and are deviated from the first nozzle group by ½ pitch in the sub scanning direction; and
a control unit which controls scanning of the print head in a main scanning direction and ink discharging from the first and second nozzle groups,
wherein the control unit controls to perform printing in any one of a plurality of printing modes including,
a first printing mode in which printing is performed such that slow permeation black ink is discharged through the first nozzle group while excessive permeation black ink is not discharged through the second nozzle group, and
a second printing mode in which a movement speed of the print head is faster than that in the first printing mode, one band is printed with one scanning of the print head and printing is performed such that slow permeation black ink is discharged through the first nozzle group and excessive permeation black ink is discharged through the second nozzle group.

2. The printing apparatus according to claim 1,
wherein the control unit controls to change a mixing ratio of excessive permeation black ink to slow permeation black ink such that as a pixel value is made larger, a ratio of the excessive permeation black ink with respect to a discharged ink amount is larger, in the second printing mode.

3. The printing apparatus according to claim 1,
wherein the print head further includes a third nozzle group in which a plurality of nozzles which discharge excessive permeation color ink are arranged at the same pitch as the first nozzle group in the sub scanning direction and are arranged such that the pitch in the third nozzle group is aligned with that in the second nozzle group in the sub scanning direction,
the control unit, when color printing is performed in the first printing mode, controls to perform printing such that slow permeation black ink is discharged through the first nozzle group and excessive permeation color ink is discharged through the third nozzle group while excessive permeation black ink is not discharged through the second nozzle group, and
the control unit, when color printing is performed in the second printing mode, controls to perform printing such that slow permeation black ink is discharged through the first nozzle group, excessive permeation black ink is discharged through the second nozzle group, and excessive permeation color ink is discharged through the third nozzle group.

4. The printing apparatus according to claim 1,
the control unit controls to perform printing such that excessive permeation black ink is discharged through the second nozzle group while slow permeation black ink is not discharged through the first nozzle group in accordance with a type of a recording medium in the first printing mode.

5. The printing apparatus according to claim 3,
the control unit controls to perform printing such that excessive permeation black ink is discharged through the second nozzle group and excessive permeation color ink is discharged through the third nozzle group while slow permeation black ink is not discharged through the first nozzle group in accordance with a type of a recording medium in the first printing mode.

6. A method for controlling a printing apparatus, the printing apparatus including;
a print head which includes a first nozzle group in which a plurality of nozzles which discharge slow permeation black ink are arranged at a predetermined pitch in a sub scanning direction, and a second nozzle group in which a plurality of nozzles which discharge excessive permeation black ink are arranged at the same pitch as the first nozzle group in the sub scanning direction and are deviated from the first nozzle group by ½ pitch in the sub scanning direction; and
a control unit which controls scanning of the print head in a main scanning direction and ink discharging through the first and second nozzle groups,
wherein the control unit performs printing in any one of a plurality of printings including;
a first printing in which printing is performed such that slow permeation black ink is discharged through the first nozzle group while excessive permeation black ink is not discharged through the second nozzle group, and
a second printing in which the movement speed of the print head is faster than that in the first printing, one band is printed with one scanning of the print head and printing is performed such that slow permeation black ink is discharged through the first nozzle group and excessive permeation black ink is discharged through the second nozzle group.
